(19) United States
(12) Patent Application Publication
(10) Pub. No.: US 2020/0034190 A1
(43) Pub. Date: Jan. 30, 2020

(54) LIVE MIGRATION OF VIRTUAL MACHINES BETWEEN HETEROGENEOUS VIRTUALIZED COMPUTING ENVIRONMENTS

(71) Applicant: VMware, Inc., Palo Alto, CA (US)

(72) Inventors: Gabriel TARASUK-LEVIN, San Jose, CA (US); Nathan L. PRZIBOROWSKI, Sonoma, CA (US)

(21) Appl. No.: 16/044,174

(22) Filed: Jul. 24, 2018

(51) Int. Cl. G06F 9/48; G06F 9/455; G06F 9/445; G06F 9/4401; G06F 9/54

(52) U.S. Cl. CPC G06F 9/4856; G06F 9/45558; G06F 9/44505; G06F 2009/45562; G06F 9/541; G06F 2009/4557; G06F 9/4401

(57) ABSTRACT

The disclosure provides an approach for dynamically creating CPU compatibility between a set of hosts to facilitate migration of virtual machines within the set of hosts. The approach involves obtaining CPU features of all hosts, finding a common denominator of features among the hosts, and creating a mask to block discovery of heterogeneous CPU features. Discovery of only common CPU features among hosts, by a VM, creates an appearance to the VM that all CPUs among the set of hosts are the same.

### BACKGROUND

Data centers often utilize virtual machines (VMs) that run within host computers. Deployment of VMs within hosts allows an efficient use of the host's resources, such as central processing unit (CPU) cycles, memory, etc. VMs may be instantiated on host machines that have varying types of CPUs. Some host machines have older CPUs with few modern features, and some host machines have newer CPUs with many more modern features.

For example, a CPU might include the feature of Advanced Encryption Standard New Instructions (AESNI) encryption. The availability of the AESNI feature on a CPU means that the CPU has a hardware mechanism dedicated to encrypting and decrypting data by the AES encryption standard. An AESNI feature in a CPU would allow AESNI encryption and decryption to be performed much faster than if performed through software on a CPU not having a supported AESNI. Another example of a feature that might be offered by a CPU is hyper-threading, which is a hardware implementation of simultaneous multithreading that improves parallelization of computations.

When a VM first powers up in a host machine, the operating system (OS) of the VM queries the CPU of the host machine (e.g., by querying a virtual CPU within a hypervisor layer) for a list of features offered by the CPU. As used herein, the OS of a VM is referred to a “guest OS” because the VM is a guest machine running on a host computer. The guest OS of the VM then caches or stores CPU features available to the guest OS so that the guest OS knows what CPU features may be used for the optimal execution of applications within the VM.

A VM may need to be migrated from a first host to a second host, such as for load balancing or fault tolerance reasons. The second host may have a CPU with a smaller feature set than the CPU of the first host. A VM assumes that its CPU feature set will not change, because from the point of view of the VM, changing a CPU feature set is like installing a new physical CPU during the execution of the VM. However, if the feature set available to a guest OS becomes smaller after VM migration to the second host, then the VM will encounter errors while attempting to access missing CPU features on the second host.

### SUMMARY

Embodiments provide a method of determining and applying a compatibility mask to facilitate migration of virtual machines (VMs) between heterogeneous virtualized computing environments, the method comprising providing a first set of hosts, the first set of hosts comprising a first host and a second host, querying a first central processing unit (CPU) of the first host, and responsive to the querying of the first CPU, obtaining a first set of features of the first CPU. The method further comprises querying a second CPU of the second host, and responsive to the querying of the second CPU, obtaining a second set of features of the second CPU, determining a common set of CPU features between the first set of features and the second set of features, obtaining a compatibility mask based on the common set of features, and migrating a VM from the first host to the second host, wherein at least one feature of the first set of features of the first CPU has been masked, by the compatibility mask, from discovery by the VM.

Further embodiments include a non-transitory computer-readable storage medium storing instructions that, when executed by a computer system, cause the computer system to perform the method set forth above, and a computer system programmed to carry out the method set forth above.

### BRIEF DESCRIPTION OF THE DRAWINGS

FIG. 1 depicts a block diagram of a computer system in which one or more embodiments of the present disclosure may be utilized.

FIG. 2 depicts a flow diagram of a method of dynamically determining a mask and applying the mask to CPU ID(s) to facilitate migration of VMs between heterogeneous virtualized computing environments, according to an embodiment.

FIG. 3 depicts a flow diagram of a method of dynamically determining a cluster of hosts that have a certain CPU feature set, according to an embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for dynamically creating CPU compatibility between a set of hosts to facilitate migration of virtual machines within the set of hosts. In the approach, CPU features of all hosts are obtained and then analyzed to find a common denominator of features. A mask is then created to block discovery, by guest OS's, of heterogeneous CPU features. Discovery of only common CPU features among hosts, by a VM, creates an illusion for the VM that all CPUs among the set of hosts are the same, even if the CPUs differ. This results in a VM not being aware of having been migrated to another host. The present disclosure also provides an approach for determining a set of hosts that all have a given set of CPU features, and subsequently, creating a mask for that set of hosts.

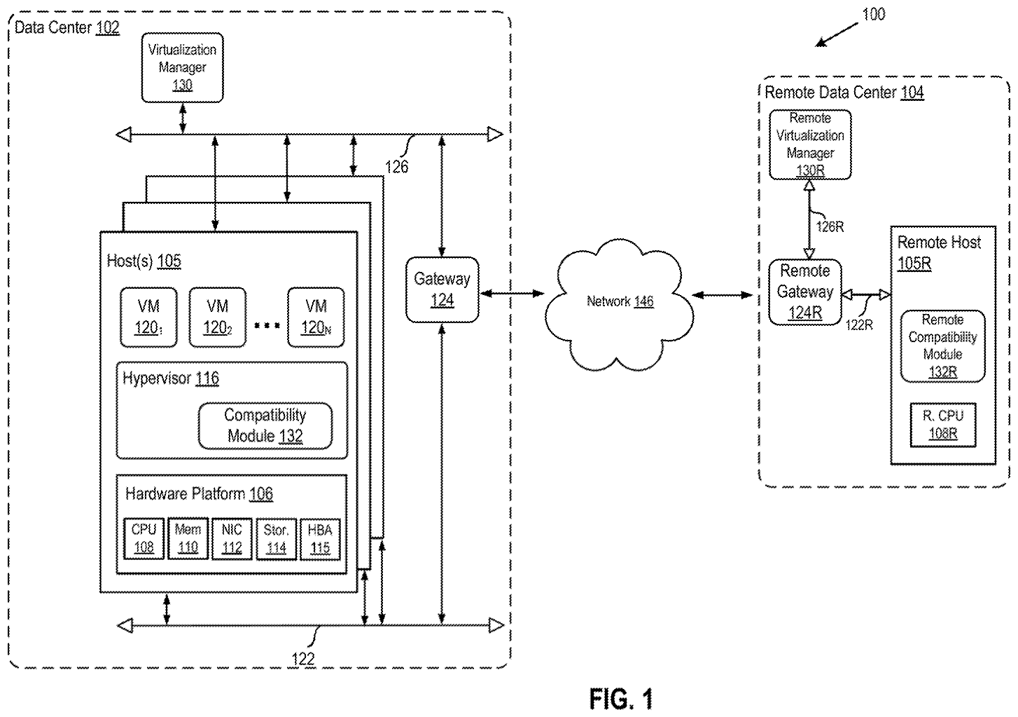

FIG. 1 depicts a block diagram of a computer system 100 in which one or more embodiments of the present disclosure may be utilized. Computer system 100 includes data center 102 and remote data center 104, connected by a network 146. Data center 102 may be an on-premise data center or a cloud data center, and data center 104 may also be an on-premise data center or a cloud data center.

A distinction between “on-premise” and “cloud” is that on-premise infrastructures are typically accessed by users through a local area network (LAN), while cloud-based infrastructures are typically accessed by users through a WAN. Cloud architectures are used in cloud computing and cloud storage systems for offering infrastructure-as-a-service (IaaS) cloud services. Examples of cloud architectures include the VMware vCloud Director® cloud architecture software, Amazon EC2™ web service, and OpenStack™ open source cloud computing service. IaaS cloud service is a type of cloud service that provides access to physical and/or virtual resources in a cloud environment. These services provide a tenant application programming interface (API) that supports operations for manipulating IaaS constructs, such as virtual machines (VMs) and logical networks.

A cloud data center may be a private cloud that serves a single tenant, a public cloud that serves multiple tenants, or a hybrid cloud. As used herein, an internal cloud or “private” cloud is a cloud in which a tenant and a cloud service provider are part of the same organization, while an external or “public” cloud is a cloud that is provided by an organization that is separate from a tenant that accesses the external cloud. A hybrid cloud is a cloud architecture in which a tenant is provided with seamless access to both private cloud resources and public cloud resources. Network 146 may be, for example, a direct link, a LAN, a wide area network (WAN) such as the Internet, another type of network, or a combination of these.

Data center 102 includes host(s) 105, a virtualization manager 130, a gateway 124, a management network 126, and a data network 122. Each of hosts 105 may be constructed on a server grade hardware platform 106, such as an x86 architecture platform. For example, hosts 105 may be geographically co-located servers on the same rack. Host 105 is configured to provide a virtualization layer, also referred to as a hypervisor 116, that abstracts processor, memory, storage, and networking resources of hardware platform 106 into multiple virtual machines 120₁ to 120_{N} (collectively referred to as VMs 120 and individually referred to as VM 120) that run concurrently on the same host. Hypervisor 116 may run on top of the operating system in host 105 or directly on hardware platform 106 of host 105. One example of a hypervisor 116 that may be used is a VMware ESXi™ hypervisor provided as part of the VMware vSphere® solution made commercially available from VMware, Inc. of Palo Alto, Calif.

Each of VMs 120 has a guest OS (not shown) that interacts with hypervisor 116. When the guest OS interacts with hypervisor 116, the guest OS believes that it is interacting with physical hardware, such as with a physical CPU 108. When VM 120 is instantiated (i.e., powered on), guest OS of VM 120 goes through a boot up sequence of steps. These steps include querying hypervisor 116, which the guest OS perceives as physical hardware, for CPU features available to the guest OS. Hypervisor 116 in turn queries CPU 108 and passes the response on to guest OS of VM 120. After receiving the CPU feature set available to it, guest OS caches or stores this feature set and references it when executing processes within VM 120. The cached CPU feature set is considered part of the “state” of VM 120, and is not reset until VM 120 is power cycled (turned off and then back on).

Because hypervisor 116 is an intermediate agent between the query for CPU feature set by guest OS of VM 120 and the response by physical CPU 108, hypervisor 116 is able to modify the response of CPU 108 before passing the feature set on to guest OS of VM 120. That is, hypervisor 116 is able to mask certain features of CPU 108 so that those features are not discovered by guest OS of VM 120, and guest OS of VM 120 executes as though those features are not available to it. This masking function is performed by compatibility module 132, as described further below.

Hardware platform 106 of each host 105 may include components of a computing device such as one or more processors (CPUs) 108, system memory 110, a network interface 112, storage system 114, a local host bus adapter (HBA) 115, and other I/O devices such as, for example, a mouse and keyboard (not shown). Network interface 112 enables host 105 to communicate with other devices via a communication medium, such as data network 122 or network 126. Network interface 112 may include one or more network adapters, also referred to as Network Interface Cards (NICs). Storage system 114 represents local persistent storage devices (e.g., one or more hard disks, flash memory modules, solid state disks, and/or optical disks). Host bus adapter (HBA) couples host 105 to one or more external storages (not shown), such as a storage area network (SAN). Other external storages that may be used include network-attached storage (NAS) and other network data storage systems, which may be accessible via NIC 112.

CPU 108 is configured to execute instructions, for example, executable instructions that perform one or more operations described herein and that may be stored in system memory 110 and in storage 114. CPU 108 may be queried for a feature set of CPU 108. The query may be in the form of a command, such as by a command having a “CPUID” opcode in an x86 architecture. In an embodiment, the feature set of CPU 108 may be provided through an array of bits. Each index in the array may represent a feature of CPU 108, and the value 0 in the index may mean that the feature is not available on CPU 108, while the value 1 in the index may mean that the feature is available on CPU 108.

For example, the feature set array may have a length of four, indexed 0, 1, 2, and 3. The zeroth index may represent the AESNI encryption/decryption feature, and the first index may represent the hyper-threading feature. If when queried for its feature set, CPU 108 returns the bit-array of “0100,” then it can be inferred that CPU 108 does not have the AESNI feature, has the hyper-threading feature, and does not have the features represented by indices 2 and 3 of the bit-array.

In an embodiment, the feature set of CPU 108 may be divided into multiple 32-bit arrays, with each 32-bit array providing information on a portion of the feature set of CPU 108. For example, if CPU 108 has 64 features, the feature set of CPU 108 may be divided into two 32-bit arrays, and each array may be obtained by one or more commands. Continuing the example, if CPU 108 within an x86 architecture is queried with an opcode of “CPUID” while the EAX register of CPU 108 is set to 1, then CPU 108 may then populate each of the EDX and ECX registers with a 32-bit array, with each 32-bit array representing a portion of the feature set of CPU 108. The bits of registers EDX and ECX may then be analyzed by an OS or other software module so as to discover CPU features available on CPU 108.

System memory 110 is hardware allowing information, such as executable instructions, configurations, and other data, to be stored and retrieved. Memory 110 is where programs and data are kept when CPU 108 is actively using them. Memory 110 may be volatile memory or non-volatile memory. Volatile or non-persistent memory is memory that needs constant power in order to prevent data from being erased. Volatile memory describes conventional memory, such as dynamic random access memory (DRAM). Non-volatile memory is memory that is persistent (non-volatile). Non-volatile memory is memory that retains its data after having power cycled (turned off and then back on). Non-volatile memory is byte-addressable, random access non-volatile memory.

Virtualization manager 130 communicates with hosts 105 via a network, shown as a management network 126, and carries out administrative tasks for data center 102 such as managing hosts 105, managing local VMs 120 running within each host 105, provisioning VMs, migrating VMs from one host to another host, and load balancing between hosts 105. Virtualization manager 130 may be a computer program that resides and executes in a central server in data center 102 or, alternatively, virtualization manager 130 may run as a virtual appliance (e.g., a VM) in one of hosts 105. One example of a virtualization manager is the vCenter Server™ product made available from VMware, Inc.

In one embodiment, virtualization manager 130 includes a hybrid cloud management module (not shown) configured to manage and integrate virtualized computing resources provided by remote data center 104 with virtualized computing resources of data center 102 to form a unified computing platform. Hybrid cloud manager module is configured to deploy VMs in remote data center 104, transfer VMs from data center 102 to remote data center 104, and perform other “cross-cloud” administrative tasks. In one implementation, hybrid cloud manager module is a plug-in complement to virtualization manager 130, although other implementations may be used, such as a separate computer program executing in a central server or running in a VM in one of hosts 105. One example of hybrid cloud manager module is the VMware vCloud Connector® product made available from VMware, Inc.

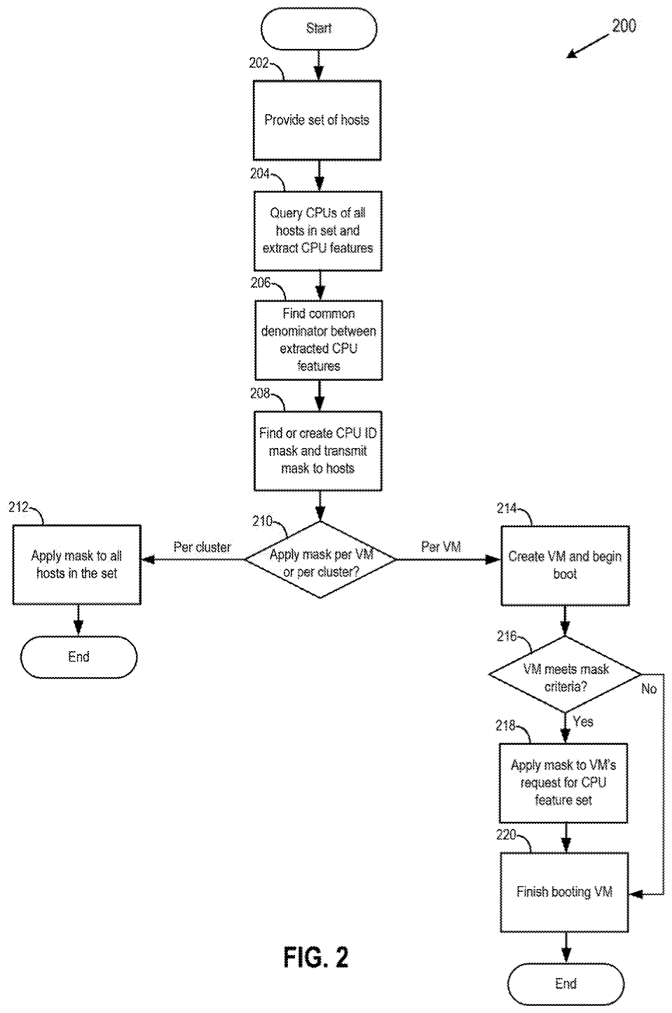

Virtualization manager 130 includes functionality for querying each CPU 108 of hosts 105 in data center 102 for a feature set of that CPU 108. Virtualization manager 130 also includes functionality for querying each CPU 108 of a set of user-specified hosts 105 in data center 102 for a feature set of that CPU 108. The set of analyzed hosts 105 may span data centers. Virtualization manager 130 analyzes obtained feature sets from each CPU 108 and compares the feature sets to one another. Virtualization manager determines the set of CPU features common to all analyzed hosts 105, i.e. virtualization manager finds a “common denominator” of CPU features between the analyzed hosts 105. Virtualization manager 130 is able to then retrieve a pre-created compatibility mask or to create a new compatibility mask. A “compatibility mask” is an array of bits, such as 0's and 1s. When a compatibility mask is applied by compatibility module 132 to a feature set of CPU 108, the compatibility mask masks certain features of CPU 108 from being discovered by guest OS of VMs 120. The masking may be performed by, for example, an AND operation between the bits of the mask and the bits of the feature set or a portion of the feature set of CPU 108. For example, if the presence of certain feature within a CPU feature set is represented by 1 bit within the array of bits representing the feature set, then to mask that feature, the compatibility mask would comprise an array of bits, and the array contains a 0 (zero) bit in the same index location as the certain feature to be masked. Performing an AND operation on the two arrays would result in an array with a 0 (zero) bit in the index location representing the certain feature that was to be masked. For an example of creating and applying a compatibility mask, see description of FIG. 2, below.

The masking may be performed on all VMs 120 or on a set of VMs 120 specified by a user or automatically selected based on a set of criteria. Virtualization manager 130 pushes compatibility mask(s) to compatibility module 132 upon retrieving or creating the compatibility mask(s). In an embodiment, virtualization manager 130 only pushes the compatibility mask(s) needed by compatibility module 132 for VM(s) 120 running on hypervisor 116 of compatibility module 132.

Virtualization manager 130 also includes functionality for, given a set of CPU features, searching CPUs of a set of hosts 105 for those given features. Subsequently, virtualization manager 130 may add hosts 105 that have CPUs 108 with the given features to a list or a logical cluster. All hosts with a given set of CPU features may then be used to host a set of VMs 120, with those VMs 120 being free to migrate between their logical cluster without loss of the given features. Subsequent to finding the logical cluster of hosts 105 in which each host 105 has given CPU features, virtualization manager 130 may analyze hosts 105 within the logical cluster for a common denominator of CPU features, and may then create a mask to be used by compatibility module 132 within hypervisor 116 of each host 105 within that logical cluster of hosts.

VM 120 may be migrated by VM migration methods known in the art, such as the method described in U.S. patent application Ser. No. 13/760,868, filed Feb. 6, 2013, or the method described in U.S. Pat. No. 9,870,324, issued Jan. 16, 2018. The entire contents of both of these documents are incorporated by reference herein.

Hypervisor 116 includes compatibility module 132. Compatibility module 132 maintains compatibility masks (not shown), as provided by virtualization manager 130. As described above, guest OS of VM 120 queries hypervisor 116 for CPU features available to the guest OS during the boot up process of the guest OS. Hypervisor 116 in turn queries CPU 108 and passes the response to guest OS of VM 120. Before passing the feature set of CPU 108 to guest OS of VM 120, hypervisor provides the feature set of CPU 108 to compatibility module 132. Compatibility module 132 checks whether any compatibility masks exist for the VM whose guest OS requested the CPU feature set. If a compatibility mask exists, then compatibility module 132 applies the compatibility mask to the feature set of CPU 108 so as to mask certain feature(s) from being discovered by the guest OS of VM 120.

Compatibility module 132 may also contain one or more rules for compatibility mask(s) or for VMs 120. The rules may specify, for example, which mask applies to which VM 120. The rules may also specify a set of hosts to which VMs 120 may or may not be migrated. The rules may be created by virtualization manager 130 and transmitted to compatibility module 132.

The step of checking for existence of a compatibility mask in respect to a specific VM is optional, because compatibility module 132 might contain a single mask, and that mask might apply to all VMs 120 running on host 105 of that compatibility module 132. When a single compatibility mask applies to all VMs 120 running on host 105, the mask may be applied automatically to the feature set being returned to guest OS of VM 120. In an embodiment, the feature set or portions of feature set of CPU 108 may be cached within compatibility module 132 so that CPU 108 does not need to be queried for a feature set each time VM 120 is instantiated.

Gateway 124 provides VMs 120 and other components in data center 102 with connectivity to network 146 used to communicate with remote data center 104. Gateway 124 may manage external public IP addresses for VMs 120 and route traffic incoming to and outgoing from data center 102 and provide networking services, such as firewalls, network address translation (NAT), dynamic host configuration protocol (DHCP), and load balancing. Gateway 124 may use data network 122 to transmit data network packets to hosts 105. Gateway 124 may be a virtual appliance, a physical device, or a software module running within host 105. One example of a gateway 124 is the NSX Edge™ services gateway (ESG) product made available from VMware, Inc.

Remote data center 104 is depicted as a simplified data center relative to data center 102. Remote data center 104 may be substantially similar to data center 102 and may include the same components as data center 102. Components in remote data center 104 may be substantially similar to analogous components in data center 102. For brevity, only remote gateway 124R, remote virtualization manager 130R, and remote host 105R are shown within remote data center 104. Remote host 105R may be substantially similar to host 105, and only some component of remote host 105R are shown (i.e., remote compatibility module 132R and remote CPU 108R). Components in remote data center 104 may be connected substantially the same as components in data center 102 (e.g., through a data network 122R and a management network 126R).

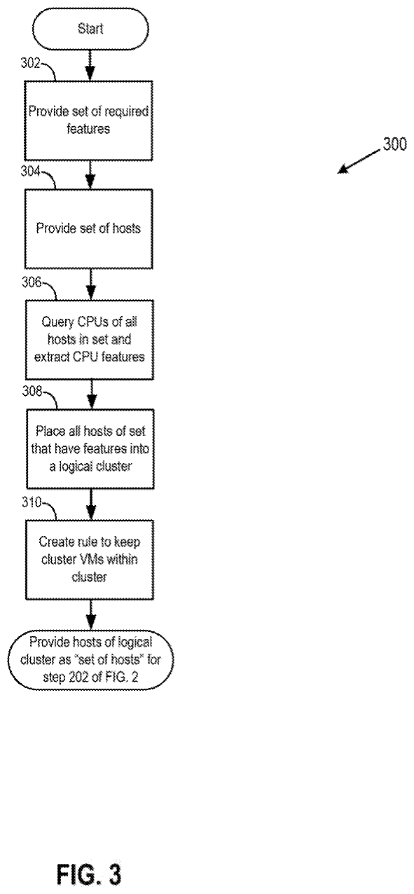

FIG. 2 depicts a flow diagram of a method 200 of dynamically determining a mask and applying the mask to a CPU feature sets to facilitate migration of VMs between heterogeneous virtualized computing environments, according to an embodiment. At step 202, a set of hosts 105 is provided. The size of the set of hosts 105 is at least two, because migration of VMs between hosts 105 requires at least two hosts 105. The set of hosts may be provided by an administrator, or may be chosen by a software module, such as virtualization manager 130, based on automatically determined or manually provided criteria. The set of hosts may also be provided as an end product of process 300, discussed below with reference to FIG. 3. The set of hosts may be within the same data center, such as data center 102, or may span multiple data centers, such as data centers 102 and 104.

At step 204, virtualization manager 130 queries CPUs 108 of all hosts 105 within the set of hosts provided at step 202. As described above, CPU 108 may be queried by a command with an opcode of “CPUID” while the EAX register of CPU 108 is set to 1. As part of step 204, virtualization manager 130 compiles feature sets of all CPUs 108 within the set of hosts 105 of step 202. For example, if three CPUs 108 are queried at step 204 and the feature set is represented by a 4-bit array, then virtualization manager 130 may compile the following three feature sets: 1110, 1111, and 0111.

At step 206, virtualization manager 130 analyzes feature sets collected at step 204 to determine what CPU features are common to all CPUs 108 of the set of hosts 105 provided at step 202. Following from the example at step 204, the common features of 1110, 1111, and 0111 are the features represented by the middle two bits, at indices 1 and 2, of the four-bit arrays. The index count of the four-bit array begins at index 0.

At step 208, virtualization manager 130 may check a repository (not shown) of previously created masks to retrieve an applicable mask. In an embodiment, a compatibility mask, such as a previously created mask, may mask some of the common features to CPUs 108 if the choice of masks is limited. In such an embodiment, the compatibility mask, when applied to a feature set of CPU 108 allows substantially all of the common CPU features to be discovered by a VM instantiated on host 105 containing CPU 108.

Alternative to retrieving a previously created mask, virtualization manager 130 may create a new bit array that can be used as a compatibility mask for masking features of CPU 108 that are not common to all CPUs queried at step 204. Continuing the example of step 206, the mask 0110 can be applied to feature sets 1110, 1111, and 0111 using an AND operation to mask out the feature at index 0 and the feature at index 3 from being discoverable by a guest OS of VM 120. Such a masking operation would allow a guest OS to discover only the CPU features represented by the middle two bits of the four-bit array. That is, to a guest OS, the feature set returned by hypervisor 116 after application of the mask would be 0110. As part of step 208, virtualization manager 130 transmits the retrieved or created mask to compatibility module 132 of each host 105 of the set of hosts 105 of step 202.

At step 210, virtualization manager 130 determines whether the mask from step 208 should be applied per VM 120, or per “cluster” or “set” of hosts 105 provided at step 202. For example, if queries for a CPU feature set from all VMs 120 (that are instantiated on hosts 105 provided at step 202) are to be masked using the mask from step 208, then the mask is transmitted to all hosts 105 of the cluster at step 212, along with a rule specifying that the mask is to be applied to all VMs on those hosts.

However, if hosts 105 of step 202 might host VMs 120 to which a mask does not apply (e.g., because that VM 120 is not migratable), or to which a different mask is to be applied, then the mask from step 202 is applied selectively on a per-VM basis to VMs 120 at steps 214 through 220. If the mask from step 208 is to be applied selectively per VM 120, then optionally, at step 208 or another step, virtualization manager 130 transmits a rule to compatibility module 132 specifying criteria that would result in the mask applying to a given VM 120 or not applying to a given VM 120. Virtualization manager 130 may make the determination at step 210 by evaluating characteristics of hosts 105, or by evaluating input given by an administrator.

At step 212, compatibility module 132 of each host 105 in the cluster or set of hosts 105 of step 202 receives and stores the mask created at step 208. The mask is maintained by compatibility module 132. Compatibility module 132 of each host 105 in the cluster of step 202 creates a rule or receives a rule from virtualization manager 130, the rule specifying that the mask is to apply to all VMs 120 instantiated within hosts 105 of the cluster of step 202. That is, when VM 120 is instantiated and then queries hypervisor 116 for a feature set of CPU 108, compatibility module 132 applies the mask of step 208 to the feature set of CPU 108 before returning that feature set to VM 120. Continuing the example of step 208, if a VM is instantiated at host 105 with CPU feature set of 1111, then after applying the mask 0110, compatibility module 132 will return feature set 0110 to VM 120, preventing VM 120 from discovering the CPU feature represented by index 0 and index 3 of the CPU feature set.

At step 214, VM 120 is created and begins its boot up sequence. VM 120 may be created automatically by virtualization manager 130 or manually by an administrator. As part of the boot up sequence, guest OS of VM 120 queries hypervisor 116 for a CPU feature set. Hypervisor 116 obtains the feature set of CPU 108, such as by querying CPU 108, and then passes the feature set to compatibility module 132.

At step 216, compatibility module 132 determines whether VM 120 meets criteria for the application of a compatibility mask stored by compatibility module 132. An example of criteria may be whether VM 120 is migratable. If so, then VM 120 can be made migratable among a given set of hosts 105 by the application of a compatibility mask, such as the compatibility mask resulting from steps 202 through 208. If VM 120 does not meet criteria for the application of a compatibility mask, then method 200 continues to step 220, where VM 120 finishes the boot up sequence and method 200 ends. If VM 120 meets criteria for an application of a compatibility mask, then method 200 continues to step 218.

At step 218, compatibility module 132 applies a compatibility mask to the feature set of CPU 108 to mask certain features of CPU 108. Compatibility module 132 returns the masked feature set to guest OS of VM 120. Guest OS of VM 120 then caches or stores the received feature set. At step 220, VM 120 finishes its boot up sequence and method 200 ends. After method 200, VM 120 is able to migrate among hosts 105 provided at step 202, those hosts 105 having disparate CPUs 108, but VM 120 will not notice that CPUs 108 of hosts 105 are different from one another.

FIG. 3 depicts a flow diagram of a method 300 of dynamically determining a cluster of hosts that have a certain CPU feature set, according to an embodiment. FIG. 3 is one method of providing a set of hosts at step 202 of FIG. 2.

At step 302, a set of desired features is provided to virtualization manager 130. For example, a software module or a user may require a VM or set of VMs to all be very high performance VMs. That may require the VMs to run on very fast, high performance CPUs 108. The set of desired features that accomplish the high-performance may be provided. Such features may be provided by a bit-array in which each index represents a feature of CPU 108, and in which a 1 designates the required presence of that feature while a 0 means that the feature is not required and may or may not be present on CPU 108.

At step 304, a set of hosts is provided. For example, all hosts in data center 102 and/or 104 may be provided for analysis as to whether the hosts 105 contain the required features of step 302.

At step 306, virtualization manager 130 queries CPUs 108 of hosts 105 in the set of hosts 105 of step 304. Step 306 is substantially similar to step 204 of FIG. 2, as described above, but may be with a different set of hosts 105. At step 308, virtualization manager 130 analyzes each obtained feature set, either as the feature set is obtained or after all features sets of all queried CPUs 108 are obtained. If the feature set of CPU 108 contains all the required features, as specified at step 302, virtualization manager 130 adds host 105 containing that CPU 108 to a list or logical cluster of hosts 105, such that all hosts 105 within the list or logical cluster contain the required CPU features of step 302.

At step 310, virtualization manager 130 may optionally create a rule, to be transmitted to compatibility module 132 of each host 105 of the logical cluster of step 308. That rule may specify that VMs 120 instantiated on host 105 of logical cluster of step 308 may only be migrated to hosts 105 that are within the logical cluster of step 310. Virtualization manager 130 may then transmits this rule to compatibility module 132 of each host 105 of the logical cluster. After step 310, method 300 ends, and the logical cluster of step 308 may be provided as the “set of hosts” of step 202 of FIG. 2 so as to create a compatibility mask for the CPU features of hosts 105 within the logical cluster of step 308.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of determining and applying a compatibility mask to facilitate migration of virtual machines (VMs) between heterogeneous virtualized computing environments, the method comprising:
providing a first set of hosts, the first set of hosts comprising a first host and a second host;
querying a first central processing unit (CPU) of the first host, and responsive to the querying of the first CPU, obtaining a first set of features of the first CPU;
querying a second CPU of the second host, and responsive to the querying of the second CPU, obtaining a second set of features of the second CPU;
determining a common set of CPU features between the first set of features and the second set of features;
obtaining a compatibility mask based on the common set of features; and
migrating a VM from the first host to the second host, wherein (a) at least one feature of the first set of features of the first CPU has been masked, by the compatibility mask, from discovery by the VM, or (b) at least one feature of the second set of features of the second CPU has been masked, by the compatibility mask, from discovery by the VM.

2. The method of claim 1, wherein the providing a first set of hosts comprises:
providing at least one required feature;
providing a second set of hosts;
for each host in the second set of hosts:
querying a CPU of the host to obtain a CPU set of features;
determining whether the CPU set of features contains all of the at least one required feature; and
responsive to the determining, adding the host to the first set of hosts.

3. The method of claim 1, further comprising, prior to the migrating and subsequent to the obtaining:
creating the VM and initiating a booting sequence of the VM;
requesting, by the VM, an available CPU feature set;
determining whether the compatibility mask applies to the VM;
responsive to the determining, applying the compatibility mask to the available CPU feature set so as to create a masked CPU feature set;
providing the masked CPU feature set to the VM, wherein the available CPU feature set is different from the masked CPU feature set.

4. The method of claim 3, wherein the applying the compatibility mask comprises using an AND logical operation.

5. The method of claim 1, further comprising, prior to the migrating and subsequent to the obtaining:
establishing a rule within the first host or the second host to apply the compatibility mask to substantially all VMs instantiated within the first host.

6. The method of claim 1, wherein the compatibility mask, when applied to the first set of features or the second set of features:
allows substantially all of the common set of CPU features to be discovered by a VM instantiated on the first host or the second host;
masks CPU features of the first set of features that are not in the common set of CPU features from being discovered by the VM instantiated on the first host or the second host; and
masks CPU features of the second set of features that are not in the common set of CPU features from being discovered by the VM instantiated on the first host or the second host.

7. The method of claim 1, wherein the obtaining comprises:
creating the compatibility mask from on the common set of features; or
retrieving the compatibility mask based on the common set of features.

8. A non-transitory computer readable medium comprising instructions to be executed in a processor of a computer system, the instructions when executed in the processor cause the computer system to carry out a method of determining and applying a compatibility mask to facilitate migration of virtual machines (VMs) between heterogeneous virtualized computing environments, the method comprising:
providing a first set of hosts, the first set of hosts comprising a first host and a second host;
querying a first central processing unit (CPU) of the first host, and responsive to the querying of the first CPU, obtaining a first set of features of the first CPU;
querying a second CPU of the second host, and responsive to the querying of the second CPU, obtaining a second set of features of the second CPU;
determining a common set of CPU features between the first set of features and the second set of features;
obtaining a compatibility mask based on the common set of features; and
migrating a VM from the first host to the second host, wherein (a) at least one feature of the first set of features of the first CPU has been masked, by the compatibility mask, from discovery by the VM, or (b) at least one feature of the second set of features of the second CPU has been masked, by the compatibility mask, from discovery by the VM.

9. The non-transitory computer readable medium of claim 8, wherein the providing a first set of hosts comprises:
providing at least one required feature;
providing a second set of hosts;
for each host in the second set of hosts:
querying a CPU of the host to obtain a CPU set of features;
determining whether the CPU set of features contains all of the at least one required feature; and
responsive to the determining, adding the host to the first set of hosts.

10. The non-transitory computer readable medium of claim 8, further comprising, prior to the migrating and subsequent to the obtaining:
creating the VM and initiating a booting sequence of the VM;
requesting, by the VM, an available CPU feature set;
determining whether the compatibility mask applies to the VM;
responsive to the determining, applying the compatibility mask to the available CPU feature set so as to create a masked CPU feature set;
providing the masked CPU feature set to the VM, wherein the available CPU feature set is different from the masked CPU feature set.

11. The non-transitory computer readable medium of claim 10, wherein the applying the compatibility mask comprises using an AND logical operation.

12. The non-transitory computer readable medium of claim 8, further comprising, prior to the migrating and subsequent to the obtaining:
establishing a rule within the first host or the second host to apply the compatibility mask to substantially all VMs instantiated within the first host.

13. The non-transitory computer readable medium of claim 8, wherein the compatibility mask, when applied to the first set of features or the second set of features:
allows substantially all of the common set of CPU features to be discovered by a VM instantiated on the first host or the second host;
masks CPU features of the first set of features that are not in the common set of CPU features from being discovered by the VM instantiated on the first host or the second host; and
masks CPU features of the second set of features that are not in the common set of CPU features from being discovered by the VM instantiated on the first host or the second host.

14. The non-transitory computer readable medium of claim 8, wherein the obtaining comprises:
creating the compatibility mask from on the common set of features; or
retrieving the compatibility mask based on the common set of features.

15. A computer system comprising:
a first host comprising a first central processing unit (CPU);
a second host comprising a second CPU;
a first set of hosts comprising the first host and the second host; and
a processor, wherein the processor is programmed to carry out a method of determining and applying a compatibility mask to facilitate migration of virtual machines (VMs) between heterogeneous virtualized computing environments, the method comprising:
querying the first CPU of the first host, and responsive to the querying of the first CPU, obtaining a first set of features of the first CPU;
querying the second CPU of the second host, and responsive to the querying of the second CPU, obtaining a second set of features of the second CPU;
determining a common set of CPU features between the first set of features and the second set of features;
obtaining a compatibility mask based on the common set of features; and
migrating a VM from the first host to the second host, wherein (a) at least one feature of the first set of features of the first CPU has been masked, by the compatibility mask, from discovery by the VM, or (b) at least one feature of the second set of features of the second CPU has been masked, by the compatibility mask, from discovery by the VM.

16. The computer system of claim 15, wherein the providing a first set of hosts comprises:
providing at least one required feature;
providing a second set of hosts;
for each host in the second set of hosts:
querying a CPU of the host to obtain a CPU set of features;
determining whether the CPU set of features contains all of the at least one required feature; and
responsive to the determining, adding the host to the first set of hosts.

17. The computer system of claim 15, further comprising, prior to the migrating and subsequent to the obtaining:
creating the VM and initiating a booting sequence of the VM;
requesting, by the VM, an available CPU feature set;
determining whether the compatibility mask applies to the VM;
responsive to the determining, applying the compatibility mask to the available CPU feature set so as to create a masked CPU feature set;
providing the masked CPU feature set to the VM, wherein the available CPU feature set is different from the masked CPU feature set.

18. The computer system of claim 15, further comprising, prior to the migrating and subsequent to the obtaining:
establishing a rule within the first host or the second host to apply the compatibility mask to substantially all VMs instantiated within the first host.

19. The computer system of claim 15, wherein the compatibility mask, when applied to the first set of features or the second set of features:
allows substantially all of the common set of CPU features to be discovered by a VM instantiated on the first host or the second host;
masks CPU features of the first set of features that are not in the common set of CPU features from being discovered by the VM instantiated on the first host or the second host; and
masks CPU features of the second set of features that are not in the common set of CPU features from being discovered by the VM instantiated on the first host or the second host.

20. The computer system of claim 15, wherein the obtaining comprises:
creating the compatibility mask from on the common set of features; or
retrieving the compatibility mask based on the common set of features.
